(19) United States
(12) Patent Application Publication
(10) Pub. No.: US 2004/0239978 A1
(43) Pub. Date: Dec. 2, 2004

(54) Method and apparatus for tracking a plurality of image devices in a network

(75) Inventors: Scott N. Didriksen, Eagle, ID (US); Timothy P. Blair, Boise, ID (US); Charles E. Cantwell, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD CO.

(21) Appl. No.: 10/446,836

(22) Filed: May 29, 2003

(51) Int. Cl. G06F 15/00; G06F 11/30

(52) U.S. Cl. 358/1.15; 709/224

(57) ABSTRACT

A method and apparatus for tracking a plurality of image devices in a network is provided including steps of detecting an imaging device change in the network, communicating the detected change to a database tracking the plurality of image devices in the network, and updating the database based on the detected change.

### BACKGROUND OF THE INVENTION

It is known to provide a plurality of printers on a network for printing documents by many users. By way of example, a network with a large number of users may include a color printer, a high speed laser printer, and a low speed laser printer. Various users may then select the appropriate printer for their particular print job, such as the color printer for a color photo, the high speed printer for a report, or the low speed printer for a memo.

Printer changes on the network, however, cannot be adequately tracked using known techniques. By way of example, if the color printer described above is broken and removed from the network by a local user, a network administrator may not be notified by the local user. Hence, without proper notification, the network administrator will not be able to timely respond to network issues, such as ordering a new color printer to replace the broken one.

### BRIEF DESCRIPTION OF THE DRAWINGS

FIG. 1 depicts a network including a server at a monitoring station and a plurality of imaging devices at a customer site according to an embodiment of the present invention.

FIG. 2 depicts a method of operating the network of FIG. 1 according to an embodiment of the present invention.

FIG. 3 depicts a method of operating the network of FIG. 1 according to another embodiment of the present invention.

FIG. 4 depicts a method of operating the network of FIG. 1 according to another embodiment of the present invention.

FIG. 5 depicts an exemplary log file according to another embodiment of the present invention.

### DETAILED DESCRIPTION OF THE EMBODIMENTS

Reference will now be made in detail to exemplary embodiments of the invention. Wherever possible, the same reference numbers will be used throughout the drawings to refer to the same or like parts.

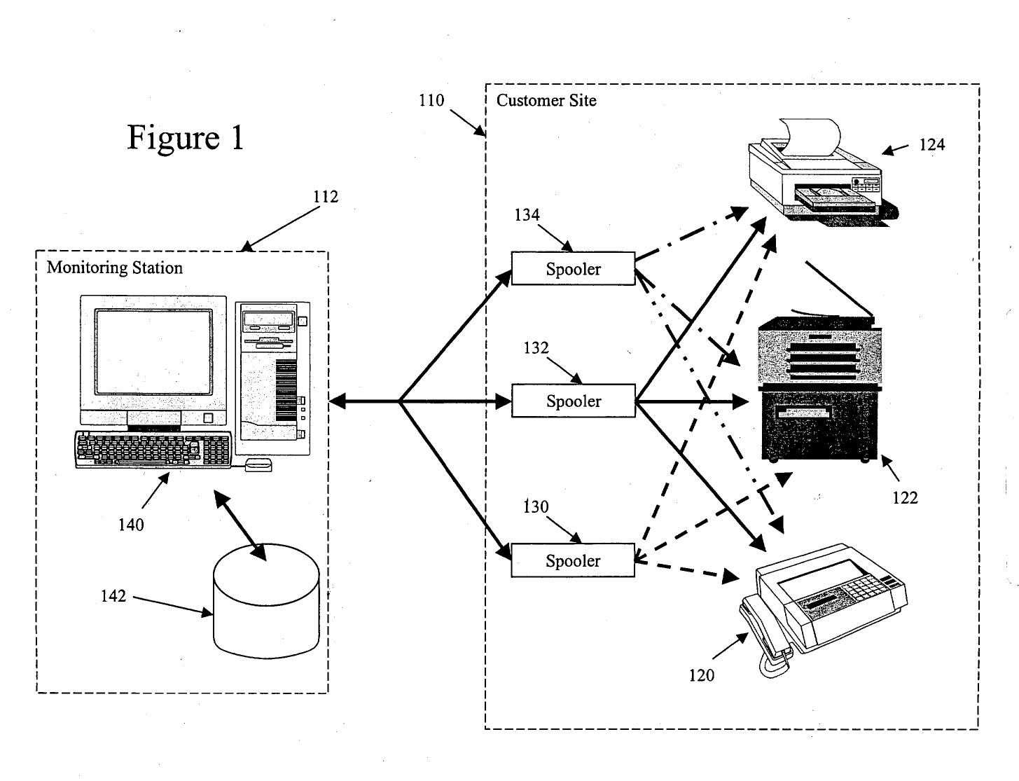

A network including a monitoring station 112, and a plurality of imaging devices at a customer site 110 according to one embodiment of the present invention is shown in the block diagram of FIG. 1. The exemplary network includes a plurality of imaging devices 120, 122, and 124 in communication with a plurality of spoolers 130, 132, and 134. For purposes of illustration only, three different imaging devices are shown, including printer 124, photocopier 122, and facsimile machine 120. Other imaging devices are also plausible, as would be readily apparent to one of ordinary skill in the art after reading this disclosure.

Spoolers 130, 132, and 134 are configured to receive imaging requests from a plurality of computers (not shown) coupled to the network, and to queue received imaging requests to the imaging devices 120, 122, and 124. Additionally, spoolers 130, 132, and 134 are configured to be in communication with database server 140 in the monitoring station 112, which tracks the plurality of imaging devices 120, 122, and 124 in database 142 (e.g., an Oracle database, a Microsoft Access database, etc.).

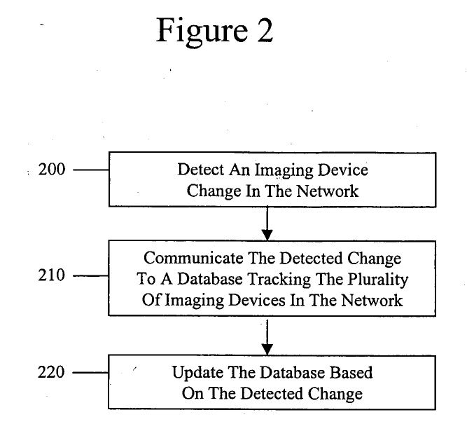

Operation of the aforedescribed network according to another embodiment of the present invention will now be set forth in reference to FIG. 2. In step 200, one (or more) of the spoolers 130, 132, and/or 134 detects an imaging device change in the network. By way of example, an imaging device change may comprise one of addition of an imaging device to the network, deletion of an imaging device from the network, replacement of an imaging device in the network, and modification of an imaging device in the network. Such a change may be caused, for example, by a local user, by a hardware failure, etc.

According to various embodiments of the present invention, step 200 may be performed by monitoring the spooler 130, 132, 134 for image forming device object changes, monitoring the spooler 130, 132, 134 for events occurring on the spooler 130, 132, 134, or both monitoring for image forming device object changes and monitoring for events occurring on the spooler 130, 132, 134. By way of example, the spooler 130, 132, 134 may monitor print object changes, such as a changed network/printing address, a changed printing device status (e.g., online, ready, offline, error, etc.), a driver change, a failure to communicate error, or other print object changes. Alternatively, the spooler 130, 132, 134 may monitor events occurring on the spooler 130, 132, 134, such as monitoring an event log on the spooler 130, 132, 134 that tracks printer additions, deletions, etc. Other techniques for performing step 200 are also encompassed (such as a combination of the two techniques noted above), as would be readily apparent to one of ordinary skill in the art after reading this disclosure.

The detected change is then communicated in step 210 to database 142 (FIG. 1) for tracking the plurality of imaging devices 120, 122, 124 in the network. By way of example, the network may be used to transmit a detected change notification from one (or more) of spoolers 130, 132, 134 to database server 140 (e.g., via http protocol). According to one embodiment of the present invention, each spooler 130, 132, 134 transmits a detected change notification individually whenever a change is detected.

After the detected change notification has been received from the spooler 130, 132, 134, the database 142 (FIG. 1) is then updated based on the detected change. By way of example, the database 142 may be automatically updated by database server 140 whenever a detected change notification has be received by the database server 140. Alternatively, database server 140 may notify a system administrator of the detected change (e.g. via an email message, a prompt on a screen, etc.), such that the system administrator may confirm that the detected change is correct, and then manually make the necessary update in the database 142.

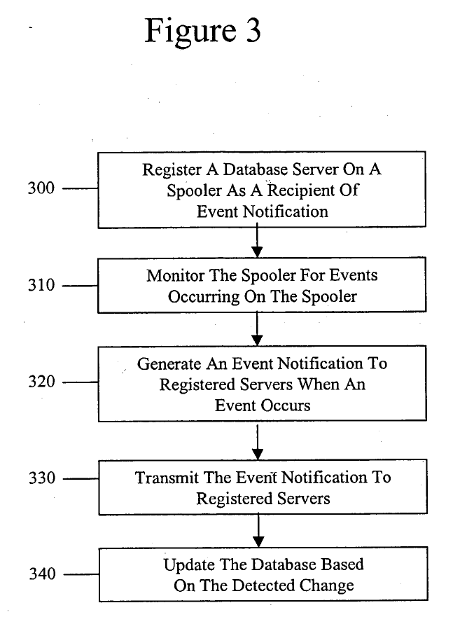

Operation of the aforedescribed network according to yet another embodiment of the present invention will now be set forth in reference to FIG. 3. In step 300, database server 140 registers on the spooler 130, 132, 134 as a recipient of event notification. By way of example, a new database server 140 may transmit a message to spooler 130, 132, 134 upon initialization. The spooler 130, 132, 134 then stores one or more registered database servers 140 in a table or log file thereon.

In step 310, the spooler 130, 132, 134 is monitored for events occurring on the spooler (e.g., by the spooler 130, 132, 134 itself, or by a central spooler monitor which may monitor one or more of spoolers 130, 132, 134) and generates an event notification in step 320 to the registered database server 140 when an event occurs. Steps 310 and 320 may be performed in a like manner as in previous embodiments. The spooler 130, 132, 134 then transmits the event notification to the registered database servers 140 in step 330. By way of example, the spooler 130, 132, 134 may transmit each event notification to all registered database servers 140 (if more than one database server 140 is registered thereon), to each registered database server 140 registered for a particular type of event, etc. The registered servers 140 in receipt of the event notification then update their given database(s) 142 based on the detected change. It should thus be appreciated that each database server 140 may be registered on one or more spooler 130, 132, 134, and each spooler 130, 132, 134 may have more than one database server 140 registered thereon.

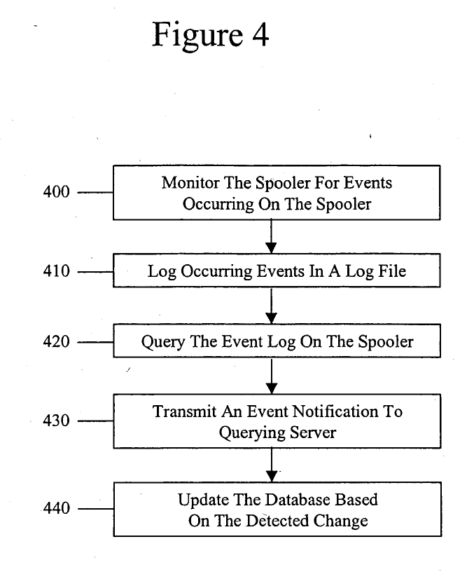

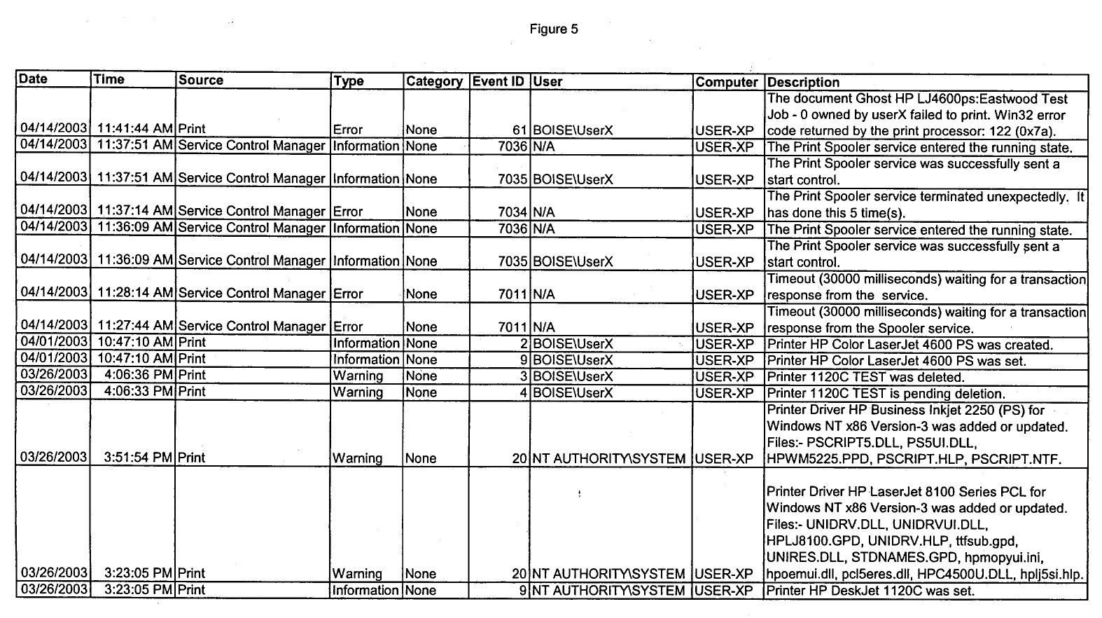

Operation of the aforedescribed network according to yet another embodiment of the present invention will now be set forth in reference to FIG. 4. In step 400, the spooler 130, 132, 134 is monitored for events occurring on the spooler 130, 132, 134 in a like manner as previously described. When an occurring event is detected, the spooler 130, 132, 134 then logs the occurring event in a log file on the spooler 130, 132, 134 (or on a central node, not shown) in step 410. Hence, the log file accumulates and stores occurring event entries for future reference. See FIG. 5 for an exemplary log file according to an embodiment of the present invention.

Periodically or upon initiation by a network administrator or other entity, the database server 140 queries the event log on the spooler 130, 132, 134 (e.g., via a Windows Management Interface). By way of example, database server 140 may query the event log on a daily basis to update the database 142 based on the last day's events. If a new event has been logged on the spooler 130, 132, 134 within the last day or since the last query, the spooler 130, 132, 134 transmits an event notification to the querying database server 140 in step 430. If no new event has been logged on the spooler 130, 132, 134 within the last day or since the last query, the spooler may or may not transmit a notification of the same to the querying database server 140 depending on the particular implementation desired. The database server 140 then updates the database 142 in step 440 in a like manner as previously described.

The aforementioned embodiments provide for accurately tracking image forming devices 120, 122, 124 as a managed fleet of image forming devices 120, 122, 124. In this manner, an offsite or on-site monitoring station 112 can accurately track changes in a fleet of image forming devices 120, 122, 124 at a customer site 110 (FIG. 1). In some embodiments, an entirely automated process can be used to provide instantaneously up-to-date information about the customer site 110, without polling or manual intervention, thereby allowing efficient and detailed maintenance of the customer site 110 by the monitoring station 112.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

What is claimed is:

1. A method of tracking a plurality of image devices in a network, comprising:
detecting an imaging device change;
communicating the detected change to a database tracking the plurality of image devices in the network; and
updating the database based on the detected change.

2. The method of claim 1, wherein the detected imaging device change comprises one of:
addition of an image device to the network;
deletion of an image device from the network;
replacement of an image device in the network; and
modification of an image device in the network.

3. The method of claim 1, wherein the database is located on a server at an offsite monitoring station.

4. The method of claim 1, wherein detecting the imaging device change comprises at least one of:
monitoring a spooler for image device object changes; and
monitoring the spooler for events occurring on the spooler.

5. The method of claim 4, wherein the spooler is located at a customer site.

6. The method of claim 4,
wherein detecting the imaging device change comprises monitoring the spooler for events occurring on the spooler, and
wherein monitoring the spooler for events occurring on the spooler comprises querying an event log on the spooler.

7. The method of claim 4,
wherein detecting the change comprises monitoring the spooler for events occurring on the spooler,
wherein monitoring the spooler for events occurring on the spooler comprises:
registering a database server on the spooler as a recipient of event notifications; and
generating an event notification for registered servers when an event occurs, and
wherein communicating the detected change transmits generated event notifications to registered database servers.

8. The method of claim 4,
wherein detecting the change comprises monitoring the spooler for image device object changes, and
wherein image device objects comprise at least one of a network address, an imaging device status, a driver change, and a failure to communicate error.

9. The method of claim 1, wherein the database is automatically updated when the imaging device change is detected.

10. The method of claim 1, wherein a database administrator updates the database when the imaging device change is detected.

11. The method of claim 1, wherein the plurality of image devices comprise at least one of a plurality of printers, a plurality of photocopiers, and a plurality of facsimile machines.

12. A network including a plurality of imaging devices, comprising:
at least one spooler configured to:
spool imaging jobs for the plurality of imaging devices; and
detect imaging device changes in the network; and
at least one server for accessing a database that tracks the plurality of imaging devices in the network,
wherein the at least one spooler notifies the at least one server of detected imaging device changes.

13. The network of claim 12, wherein the detected imaging device change comprises one of:
addition of an imaging device to the network;
deletion of an imaging device from the network;
replacement of an imaging device in the network; and
modification of an imaging device in the network.

14. The network of claim 12, wherein the at least one spooler is located at a customer site.

15. The network of claim 12, wherein the server is located at an offsite monitoring station.

16. The network of claim 12, wherein the database is automatically updated when the imaging device change is detected.

17. The network of claim 12, wherein a database administrator updates the database when the imaging device change is detected.

18. The network of claim 12, wherein the at least one spooler detects imaging device changes by at least one of:
monitoring image forming device object changes; and
monitoring events occurring on the at least one spooler.

19. The network of claim 18, wherein monitoring events occurring on the at least one spooler comprises querying an event log on the at least one spooler.

20. The network of claim 18, wherein monitoring events occurring on the at least one spooler comprises:
registering the at least one server on the at least one spooler as a recipient of event notification; and
generating an event notification to registered servers when an event occurs, and
wherein the at least one spooler notifies the at least one server of detected changes by transmitting the event notification to the at least one server.

21. The network of claim 12, wherein the plurality of imaging devices comprise at least one of a plurality of printers, a plurality of photocopiers, and a plurality of facsimile machines.

22. A printer management system, comprising:
means for spooling print jobs for a plurality of printers;
means for detecting changes in the plurality of printers; and
means for tracking the detected changes.

23. The printer management system of claim 22, wherein a change comprises one of:
addition of a printer to the system;
deletion of a printer from the system;
replacement of a printer in the system; and
modification of a printer in the system.

24. The printer management system of claim 22,
wherein the means for spooling print jobs is located at a customer site, and
wherein the means for tracking the detected changes is located at an offsite monitoring station.

25. A program product including machine readable program code for causing a spooler to perform method steps of:
spooling imaging jobs to a plurality of imaging devices on a network;
detecting imaging device changes on the spooler; and
transmitting detected changes to a server tracking the imaging device changes.

26. The program product of claim 25, wherein transmitting detected changes to the server automatically transmits detected changes upon detection thereof.

27. The program product of claim 25, further comprising machine readable code for causing the spooler to perform a step of receiving queries from the server, wherein transmitting detected changes to the server transmits detected changes upon receipt of a query from the server.

28. The program product of claim 25, wherein the detected imaging device change comprises one of:
addition of an imaging device to the network;
deletion of an imaging device from the network;
replacement of an imaging device in the network; and
modification of an imaging device in the network.

29. The program product of claim 25, wherein the plurality of imaging devices comprise at least one of a plurality of printers, a plurality of photocopiers, and a plurality of facsimile machines.

30. The program product of claim 25, wherein detecting imaging device changes on the spooler comprises at least one of:
monitoring image forming device object changes; and
monitoring events occurring on the spooler.

32. A program product including machine readable program code for causing a database server to perform method steps of:
accessing a database with tracking information for a plurality of image forming devices on a network;
receiving database tracking updates relating to image forming devices from a spooler; and
updating the database based on the received database updates.

33. The program product of claim 32, further comprising machine readable code for causing the server to perform a step of:
transmitting a query to the spooler for notification of an imaging device change.

34. The program product of claim 32, further comprising machine readable code for causing the server to perform a step of:
registering the server on the spooler as a recipient of event notification.

35. The program product of claim 32, wherein the database update comprises one of:
addition of an imaging device to the network;
deletion of an imaging device from the network;
replacement of an imaging device in the network; and
modification of an imaging device in the network.

36. The program product of claim 32, wherein the plurality of imaging devices comprise at least one of a plurality of printers, a plurality of photocopiers, and a plurality of facsimile machines.
